(19) United States
(12) Patent Application Publication
(10) Pub. No.: US 2008/0016048 A1
(43) Pub. Date: Jan. 17, 2008

(54) INTELLIGENT CONDITION PRUNING FOR SIZE MINIMIZATION OF DYNAMIC, JUST IN TIME TABLES

(76) Inventors: Richard D. Dettinger, Rochester, MN (US); Frederick A. Kulack, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/456,919

(22) Filed: Jul. 12, 2006

(51) Int. Cl. G06F 17/30

(52) U.S. Cl. 707/4

(57) ABSTRACT

A method, system and article of manufacture for managing execution of queries against heterogeneous data structures are disclosed. One embodiment provides a method of processing a database query. The method comprises receiving, from a requesting entity, an abstract query of data contained in a database and an external data source. From the abstract query, an executable query is generated that is configured to access the database and a temporary data structure generated using data from the external data source. From the executable query, a data request configured to identify the data from the external data source to be included with the temporary data structure is generated. Then, the temporary data structure is generated using the data request. The executable query is executed against the database and the temporary data structure to obtain a result set. The obtained result set is returned to the requesting entity.

### RELATED APPLICATIONS

This application is related to the commonly owned U.S. patent application Ser. No. 10/083,075, filed Feb. 26, 2002, entitled “APPLICATION PORTABILITY AND EXTENSIBILITY THROUGH DATABASE SCHEMA AND QUERY ABSTRACTION,” and to the commonly owned co-pending application, entitled “SYSTEM AND METHOD FOR CREATING AND POPULATING DYNAMIC, JUST IN TIME, DATABASE TABLES,” filed herewith (Attorney Docket No. ROC920060100US1), which are hereby incorporated herein in their entirety.

### BACKGROUND OF THE INVENTION

1. Field of the Invention

The present invention generally relates to processing database queries and, more particularly, to techniques for processing a database query using data from both a relational database and other data sources.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented database defines data in object classes and subclasses.

Regardless of the particular architecture, a DBMS can be structured to support a variety of different types of operations. Such operations can be configured to retrieve, add, modify and delete information being stored and managed by the DBMS. Standard database access methods support these operations using high-level query languages, such as the Structured Query Language (SQL). The term “query” denominates a set of commands that cause execution of operations for processing data from a stored database. For instance, SQL supports four types of query operations, i.e., SELECT, INSERT, UPDATE and DELETE. A SELECT operation retrieves data from a database, an INSERT operation adds new data to a database, an UPDATE operation modifies data in a database and a DELETE operation removes data from a database.

Any requesting entity, including applications, operating systems and users, can issue queries against data in a database. Queries may be predefined (i.e., hard coded as part of an application) or may be generated in response to input (e.g., user input). Upon execution of a query against a database, a result set is returned to the requesting entity.

However, data may often be available from sources other than a relational database. For instance, assume a query configured to retrieve information about patients in a hospital, such as name, nickname, age, gender and address. Assume further that an underlying database includes database tables that have name, age, gender, and address columns, but that the database does not include the requested nickname information. Because the query references data not in an underlying database table (specifically, the patient nickname), this query cannot be run against this database. Assume now that the nickname information can be retrieved from an external data source, such as a text file. In this case, to execute such a database query, the nickname information needs to be retrieved from the text file and included with the database. However, this approach requires that the user is authorized and able to perform any required changes to the underlying database. Alternatively, a user could manually compare query results with information from the nickname file. This approach, however, is likely to become both time consuming and error prone, in practice.

In some cases, an external data source (e.g., the text file of the previous example) may include additional information, such as information about country of origin, marital status and other personal details related to the patients in the hospital. Using this data source, a query may specify to retrieve the name, age, gender and address information as well as the additional information stored in the text file. In addition, the query may include conditions based on data from the text file. For instance, query conditions may specify to search for thirty to fifty year old married patients coming from France, Germany, Italy and the USA. Accordingly, only some of the information from the text file is required to execute such a query. Thus, including all additional information from the text file with the underlying database may often become be a waste of available resources.

Therefore, there is a need for an efficient technique for integrating data from external data sources with data from databases and for managing database query execution where the data being queried resides in both relational databases and other external data sources,

### SUMMARY OF THE INVENTION

The present invention is generally directed to a method, system and article of manufacture for managing database query execution where the data being queried resides in both relational databases and other external data sources, and, more particularly, for optimizing a process of creating a dynamic, just in time, database table.

One embodiment of the invention provides a computer-implemented method of processing a database query. The method generally includes receiving, from a requesting entity, an abstract query of data contained in a database and an external data source, wherein the abstract query is composed from one or more logical fields of a data abstraction model and generating, from the abstract query, an executable query capable of being executed by a query engine, wherein the executable query includes a reference to a temporary data structure to be generated using data from the external data source and wherein the executable query includes one or more query conditions. The method generally further includes generating a data request specifying data from the external data source required to execute the database query, wherein the data request includes at least one of the plurality of conditions, generating the temporary data structure using the data request to retrieve data from the external data source consistent with the at least one condition, and executing the executable query against the database and the temporary data structure to obtain a result set.

Another embodiment of the invention includes a computer-readable medium containing a program which, when executed by a processor, performs operations for processing a database query. The operations generally includes, from a requesting entity, an abstract query of data contained in a database and an external data source, wherein the abstract query is composed from one or more logical fields of a data abstraction model and generating, from the abstract query, an executable query capable of being executed by a query engine, wherein the executable query includes a reference to a temporary data structure to be generated using data from the external data source and wherein the executable query includes one or more query conditions. The operations may further include generating a data request specifying data from the external data source required to execute the database query, wherein the data request includes at least one of the plurality of conditions, generating the temporary data structure using the data request to retrieve data from the external data source consistent with the at least one condition, and executing the executable query against the database and the temporary data structure to obtain a result set.

Another embodiment of the invention includes computing device having a processor and a memory containing a program for optimizing a database query, which, when executed, performs an operation for processing a database query. The operation may generally include receiving, from a requesting entity, an abstract query of data contained in a database and an external data source, wherein the abstract query is composed from one or more logical fields of a data abstraction model and generating, from the abstract query, an executable query capable of being executed by a query engine, wherein the executable query includes a reference to a temporary data structure to be generated using data from the external data source and wherein the executable query includes one or more query conditions. The operation may further include generating a data request specifying data from the external data source required to execute the database query, wherein the data request includes at least one of the plurality of conditions, generating the temporary data structure using the data request to retrieve data from the external data source consistent with the at least one condition, and executing the executable query against the database and the temporary data structure to obtain a result set.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a computer system that may be used in accordance with one embodiment of the invention;

FIG. 2 is a relational view of software components used to create and execute database queries, according to one embodiment of the invention;

FIGS. 3A-3B are relational views of software components illustrating an abstract query model environment, according to one embodiment of the invention;

FIGS. 4-5 are flow charts illustrating the operation of a runtime component, according to one embodiment of the invention;

FIGS. 6-7 are flow charts illustrating a method for executing a database query, according to one embodiment of the invention;

FIGS. 8-13 illustrate a data request generated from a given query, according to one embodiment of the invention; and

FIG. 14 is a flow chart illustrating a method for creating and populating a dynamic, just in time, database table, according to one embodiment of the invention.

### DETAILED DESCRIPTION OF THE PREFERRED EMBODIMENTS

### Introduction

The present invention is generally directed to a method, system and article of manufacture for executing database queries where the data being queried resides in both relational databases and other external data sources, and, more particularly, for optimizing a process of creating a dynamic, just in time, database table. In general, queries are executed against one or more underlying databases. Typically, a database query specifies conditions used to evaluate whether a given element of data should be included in a result set and at least one result field specifying what data elements should be returned in the result set.

In one embodiment, an underlying database(s) may be accessed using one or more data abstraction models abstractly describing physical data in the underlying database(s). Such a data abstraction model may also provide users with access to data stored in external data sources. Thus, using a data abstraction model, abstract queries against the physical data can be constructed regardless of the structure or representation used by an underlying physical database and/or an external data structure. The data abstraction model may include a runtime component configured to generate an executable query from the abstract query in a form consistent with a physical representation of the data.

In one embodiment, an abstract query may reference data from both a database and an external data source. For execution, the abstract query is transformed into an executable query, (e.g., an SQL statement) that includes references to dynamic, just-in-time tables. As described in greater detail herein, a dynamic, just-in-time table may be generated using data from an external data source. The data abstraction model handles all the aspects of retrieving data from the external source, storing data in the dynamic, just-in-time tables, and joining the data from the external source with other tables in an underlying database.

Further, embodiments of the invention may optimize what information is included in from the external data source in the dynamic, just in time table, based on the content of a particular query submitted for execution. Once the dynamic, just-in-time tables is prepared, the SQL query may be executed and any resulting data records that satisfy conditions specified by the query are returned to a user.

When generating a dynamic, just-in-time table, a data request may be used to identify data from the external data source to include in a temporary data structure. In one embodiment, the data request is used to identify a portion of the data from the external data source that is needed for executing the executable query. Using this data, the temporary data structure (e.g., a dynamic, just-in-time table) is generated and linked with the database. The executable query is then executed against the database and the temporary data structure to obtain a result set. The obtained result set is returned to the requesting entity.

### Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

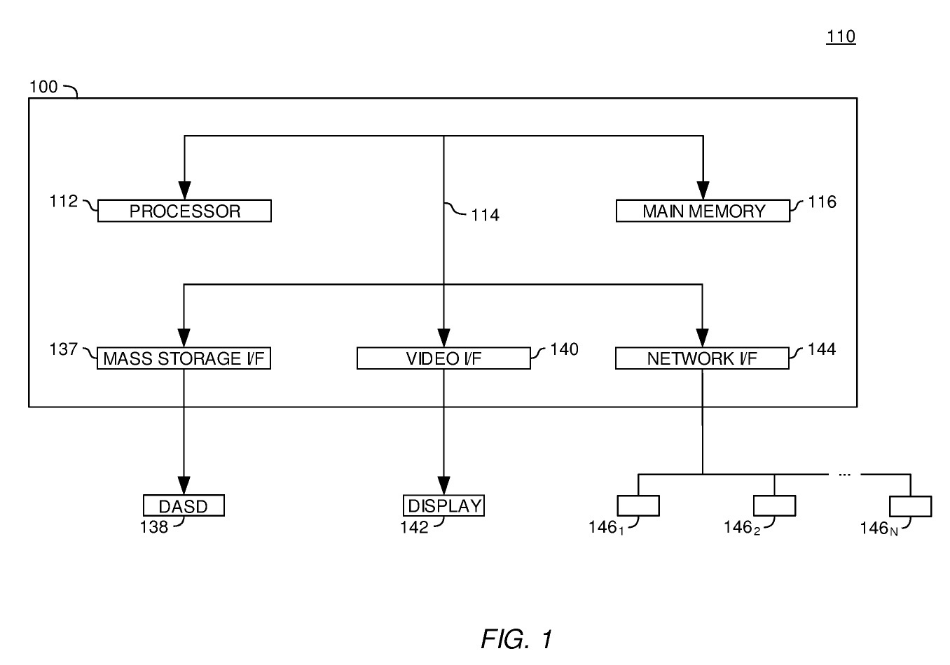

One embodiment of the invention is implemented as a program product for use with a computer system such as, for example, computer system 110 shown in FIG. 1 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD- or DVD-ROM disks readable by a CD- or DVD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

### An Exemplary Computing Environment

FIG. 1 illustrates a simplified view of a computer 100 (part of a computing environment 110). The computer 100 may represent any type of computer, computer system or other programmable electronic device, including a client computer, a server computer, a portable computer, a personal digital assistant (PDA), an embedded controller, a PC-based server, a minicomputer, a midrange computer, a mainframe computer, and other computers adapted to support the methods, apparatus and article of manufacture of the invention. The invention, however, is not limited to any particular computing system, device or platform and may be adapted to take advantage of new computing systems and devices as they become available.

Illustratively, the computer 100 is part of a networked system 110. In this regard, the invention may be practiced in a distributed computing environment in which tasks are performed by remote processing devices that are linked through a communications network. In a distributed computing environment, program modules may be located in both local and remote memory storage devices. In another embodiment, the computer 100 is a standalone device. The computer may be a standalone device or part of a network in which case the computer may be coupled by communication means (e.g., a local area network or a wide area network) to another device (i.e., another computer).

In any case, it is understood that FIG. 1 is merely one configuration for a computer system. Embodiments of the invention can apply to any comparable configuration, regardless of whether the computer 100 is a complicated multi-user apparatus, a single-user workstation or a network appliance that does not have non-volatile storage of its own.

The computer 100 could include a number of operators and peripheral systems as shown, for example, by a mass storage interface 137 connected to a storage device 138, by a video interface 140 connected to a display 142, and by a network interface 144 connected to the plurality of networked devices 146 (which may be representative of the Internet) via a suitable network. Although storage 138 is shown as a single unit, it could be any combination of fixed and/or removable storage devices, such as fixed disc drives, floppy disc drives, tape drives, removable memory cards or optical storage. The display 142 may be any video output device for outputting viewable information.

Computer 100 is shown comprising at least one processor 112, which obtains instructions and data via a bus 114 from a main memory 116. The processor 112 could be any processor adapted to support the methods of the invention. In particular, the computer processor 112 is selected to support the features of the present invention.

The main memory 116 is any memory sufficiently large to hold the necessary programs and data structures. Main memory 116 could be one or a combination of memory devices, including Random Access Memory, nonvolatile or backup memory, (e.g., programmable or flash memories, read-only memories, etc.). In addition, memory 116 may be considered to include memory physically located elsewhere in the computer system 110, for example, any storage capacity used as virtual memory or stored on a mass storage device (e.g., direct access storage device 138) or on another computer coupled to the computer 100 via bus 114. Thus, main memory 116 and storage device 138 could be part of one virtual address space spanning multiple primary and secondary storage devices.

### An Exemplary Database and Query Environment

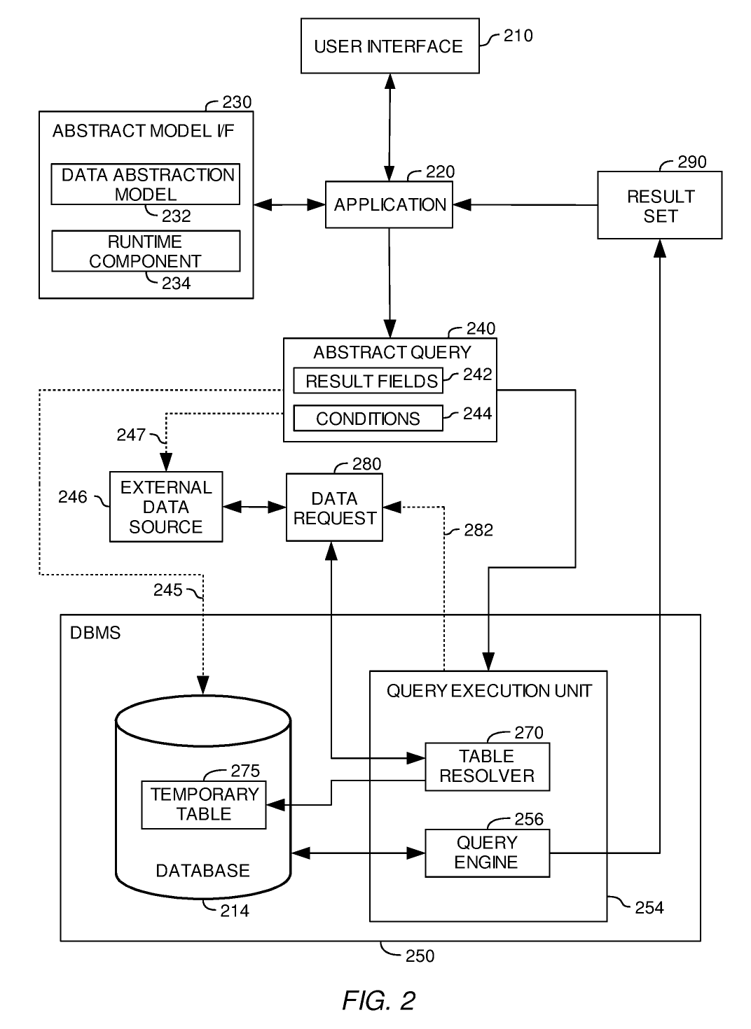

FIG. 2 illustrates a relational view of software components, according to one embodiment of the invention. Illustratively, the software components include a user interface 210, a DBMS 250, one or more external data sources 246 (only one data source is illustrated for simplicity), one or more applications 220 (only one application is illustrated for simplicity) and an abstract model interface 230. The abstract model interface 230 provides an interface to a data abstraction model 232 and a runtime component 234. The DBMS 250 includes a database 214 and a query execution unit 254. Further, as shown, query execution unit 254 includes a query engine 256 and a table resolver object 270.

According to one aspect, the application 220 (and more generally, any requesting entity) submits queries evaluated using data from database 214 and external data source 246. The database 214 is shown as a single database for simplicity. However, a given query can be executed against multiple databases which can be distributed relative to one another. Moreover, one or more databases can be distributed to one or more networked devices (e.g., networked devices 146 of FIG. 1). The database 214 is representative of any collection of data regardless of the particular physical representation of the data. A physical representation of data defines an organizational schema of the data. By way of illustration, the database 214 may be organized according to a relational schema (accessible by SQL queries) or according to an XML schema (accessible by XML queries). However, the invention is not limited to a particular schema and contemplates extension to schemas presently unknown. As used herein, the term “schema” refers to a particular arrangement of data.

In one embodiment, the external data source 246 contains data that is not available from the database 214. By way of example, the external data source 246 may be a text file that contains data with a relationship to data in the database 214. For instance, assume that the database 214 contains data about patients in a hospital, such as name, age, gender, and address information arranged in tables having name, age, gender and address columns. Assume further that the external data source 246 is a text file that contains a list of patient-name and nicknames for some patients with data in database 214. In other words, the nickname information included with the external data source 246 is related to the patient data included with the database 214, but not included therewith. Another example of external data source 246 includes a search engine configured to return documents (or references to documents) that contain one or more search terms passed with data request 280. In one embodiment, the Omnifind® search engine available from IBM may be used.

Data returned from the external data source 246 may also include metadata about the data. For example, the Omnifind® search engine may return a set of documents (or references to documents) that include one or more search terms, along with metadata specifying a score, i.e., a measure of “importance” for each document included in a set of search results, and other attributes or characteristics of the documents in the search results.

However, the type of data and whether the data in the external data source 246 relates to the data in the database 214 is not limiting of the invention. Instead, various types of data included with the external data source 246 are broadly contemplated. For instance, assume that the external data source 246 is associated with the data in the database 214 only by means of an issued query. For example, the external data source 246 may have data related to specialists in different medical domains arranged by the geographic area where a given specialist practices. In this case, the issued query can request data for patients living in a given city and having a particular disease, as well as for a specialist practicing in the area of residence of such patients. Thus, the information about the specialists is linked to the patient information only via the issued query. All such implementations are broadly contemplated.

The queries issued by the application 220 may be predefined (i.e., hard coded as part of the application 220) or may be generated in response to input (e.g., user input). In one embodiment, the queries issued by the application 220 can be created by users using the user interface 210, which can be any suitable user interface configured to create/submit queries. According to one aspect, the user interface 210 is a graphical user interface. Note, however, the user interface 210 is shown by way of example; any suitable requesting entity may create and submit queries against the database 214 (e.g., the application 220, an operating system or an end user). Accordingly, all such implementations are broadly contemplated.

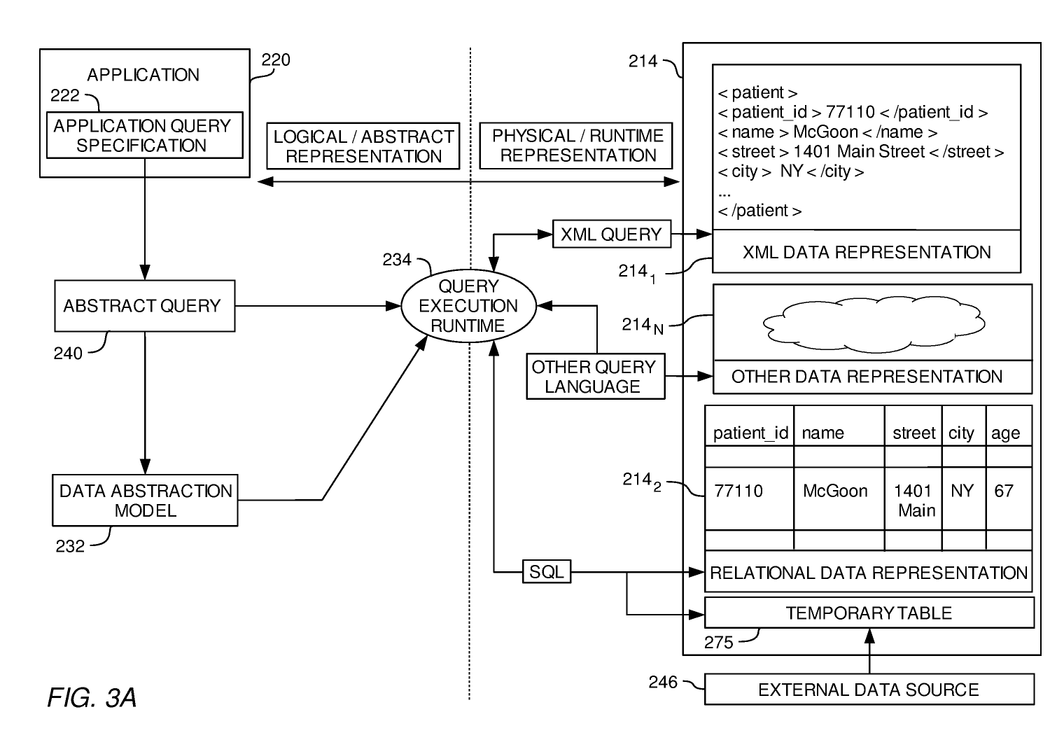

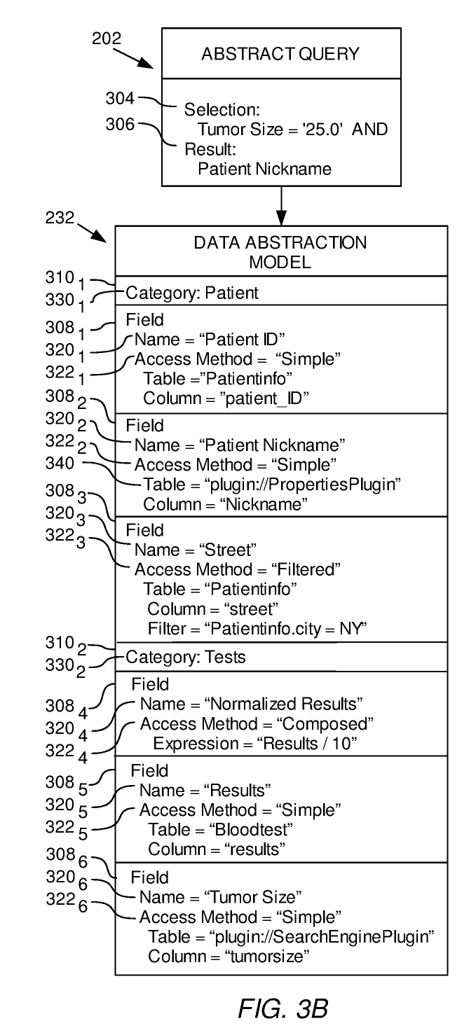

In one embodiment, the queries issued by the application 220 are composed using the abstract model interface 230. In other words, the queries are composed from logical fields provided by the data abstraction model 232 and translated by the runtime component 234 into a concrete (i.e., executable) query for execution. Such queries are referred to herein as “abstract queries.” An exemplary abstract model interface is described below with reference to FIGS. 3A-5.

Illustratively, the application 220 issues an abstract query 240 requesting data from the database 214, as illustrated by a dashed arrow 245, and data from the external data source 246, as illustrated by a dashed arrow 247. For instance, assume that the abstract query 240 requests name, age, gender and address information from the database 214 and nickname information from the external data source 246, as was noted above. To this end, the abstract query 240 may includes result fields 242 indicating what is to be returned in a result set 290. Note, however, from the user's perspective, the user may simply include the desired result fields in the query, either as result fields or as part of a query condition, regardless of whether the underlying data is part of database 214 or external data source 246. The name, age, gender, address and nickname fields correspond to logical fields defined by the data abstraction model 232. As shown, the abstract query 240 also includes one or more query conditions 244 for specifying which data contained in the database 214 and/or the external data source 246 should be returned for each one of the result fields 242. However, it should be noted that the conditions 244 are merely illustrated by way of example. In other words, abstract queries without conditions are contemplated.

As noted above, according to one aspect, the user may interact with user interface 210 to compose abstract query 240. To this end, the user interface 210 may display a suitable graphical user interface (GUI) screen for composing abstract query 240. For instance, a GUI screen can be configured to display a plurality of user-selectable elements, each representing a logical field of the data abstraction model 232 that may be selected to include in the set of result fields 242. For example, a variety of different GUI screen displays could show the “patient_id,” “name,” “age,” “gender,” “diagnosis,” “address” and “nickname” fields as user-selectable elements that may be included in an abstract query.

In one embodiment, the data abstraction model 232 includes logical fields referring to data in the database 214 and/or data in the external data source 246. Logical fields are described in greater detail below with reference to FIG. 3B. In the example described above, patient nickname information is not included with the database 214, but with the external data source 246. However, the nickname field is included with the data abstraction model 232 together with other fields relating to data included with the database 214, such as the “name,” “age,” “gender” and “address” fields.

The GUI screen displayed in the user interface 210 may also display graphical elements allowing users to specify a query condition 244 using a logical field of the data abstraction model 232. However, using a GUI to specify the abstract query 240 is merely described by way of example and not meant to be limiting of the invention. In other words, other techniques for composing an abstract query 240 may be used.

In one embodiment, the runtime component 234 generates an executable query from the abstract query. Further, the runtime component 234 may be configured to generate an executable query that includes a reference to a temporary table 275 in the database 214. The temporary table may be populated with data from the external data source 246. The size of the temporary table 275 can be minimized by filtering the data from the external data source 246 prior to populating the temporary table. In one embodiment, the filtering is performed using a data request 280 generated by the query execution unit 254, on the basis of the executable query (as illustrated by a dashed arrow 282). An exemplary embodiment of the operations of the runtime component 234 for generating the executable query and the data request 280, and for generating a temporary table 275 using data from the external data source 275 is described in greater detail below.

The executable query is submitted to the query execution unit 254 for execution against database 214. Query execution unit 254 identifies the reference to the temporary table 275 in the executable query and generates data request 280. Then, query execution unit 254 creates an appropriate instance of table resolver object 270, which may be configured to retrieve data from the external data source 246 and generate the temporary table 275. More generally, a given table resolver object 270 may implement methods for (1) initializing an instance of the table resolver object, (2) generating a temporary table, and (3) removing or cleaning-up the temporary table 275 once it is no longer needed (i.e., after a query has been executed). By way of example, an initialization method may be configured to determine whether the external data source 246 exists and, if so, whether a database or network connection is required to access the external data source 246. If so, the initialization method can further be configured to establish the required database or network connection. The specific actions required to initialize a table resolver object 270 (if any) will typically depend on the particular implementation. Generally however, the initialization method allows a table resolver object 270 to perform any actions that need to be performed only once for an instance of that table resolver object.

A table generation method may be invoked to generate the temporary table 275 and link the temporary table with data in the database 214. A removal method may be invoked to remove the temporary table 275 after query execution. In one embodiment, the generation method may be further configured to generate a reference that may be used by identify a particular temporary table; such a reference may be passed between components of the query executing unit 254.

The query execution unit 254 then uses the query engine 256 to execute the executable query against the database 214, including queries that retrieve data from a dynamic, just in time table. As shown, the query execution unit 254 includes only the query engine 256 for query execution, for simplicity. However, the query execution unit 254 may include other components, such as a query parser and a query optimizer. A query parser is generally configured to accept a received query input from a requesting entity, such as the application(s) 220, and then parse the received query. The query parser may then forward the parsed query to the query optimizer for optimization. A query optimizer is an application program which is configured to construct a near optimal search strategy (known as an “access plan”) for a given set of search parameters, according to known characteristics of an underlying database (e.g., the database 214), an underlying system on which the search strategy will be executed (e.g., computer system 110 of FIG. 1), and/or optional user specified optimization goals. In general, such search strategies determine an optimized use of available hardware/software components to execute a query. Once an access plan is selected, the query engine 256 then executes the query according to the access plan.

When executing a query against database 214 (including temporary table 275), query engine 256 identifies each data record of database 214 and, thus, temporary table 275 that satisfies abstract query 240. Each identified data record is included with the result set 290. The result set 290 is then returned to the application(s) 220.

In one embodiment, when the result set 290 is returned to the application(s) 220, the temporary table 275 is removed from the database 214. Alternatively, the temporary table 275 is removed from the database 214 when the application(s) 220 is terminated. In other words, temporary table 275 is dynamically generated in and removed from database 214. However, other implementations are possible. For instance, temporary table 275 can be stored persistently as part of database 214. Accordingly, all such implementations are broadly contemplated.

### Logical/Runtime View of Environment

FIGS. 3A-3B show an illustrative relational view of software components, according to one embodiment of the invention. According to one aspect, the software components are configured to manage processing an abstract query. Illustratively, the software components include application 220, data abstraction model 232, runtime component 234, database 214 and external data source 246 of FIG. 2. As shown, the database 214 includes a plurality of exemplary physical data representations 214₁, 214₂, . . . 214_{N} and the temporary table 275.

As noted above with reference to FIG. 2, the application 220 issues the abstract query 240 against the database 214 and the external data source 246. In one embodiment, the application 220 issues the query 240 as defined by a corresponding application query specification 222. In other words, the abstract query 240 is composed according to logical fields rather than by direct reference to underlying physical data entities in the database 214 and/or the external data source 246. The logical fields are defined by the data abstraction model 232 which generally exposes information as a set of logical fields that may be used within a query (e.g., the abstract query 240) issued by the application 220 to specify criteria for data selection and specify the form of result data returned from a query operation. Furthermore, the abstract query 240 may include a reference to an underlying model entity that specifies the focus for the abstract query 240. In one embodiment, the application query specification 222 may include both criteria used for data selection (selection criteria 304; e.g., conditions 244 of FIG. 2) and an explicit specification of the fields to be returned (return data specification 306; e.g., result fields 242 of FIG. 2) based on the selection criteria 304, as illustrated in FIG. 3B.

The logical fields of the data abstraction model 232 are defined independently of the underlying data representation (i.e., one of the plurality of exemplary physical data representations 214_{1-N}) being used in the database 214 and/or the external data source 246, thereby allowing queries to be formed that are loosely coupled to the underlying data representation. More specifically, a logical field defines an abstract view of data whether as an individual data item or a data structure in the form of, for example, a database table. As a result, abstract queries such as the query 240 may be defined that are independent of the particular underlying data representation used. Such abstract queries can be transformed into a form consistent with the underlying physical data representation 214_{1-N} for execution against the database 214. By way of example, the abstract query 240 is translated by the runtime component 234 into an executable query executed against the database 214 to obtain a result set (e.g., result set 290 of FIG. 2) for the abstract query 240.

In one embodiment, illustrated in FIG. 3B, the data abstraction model 232 comprises a plurality of field specifications 308₁, 308₂, 308₃, 308₄, 308₅ and 308₆ (six shown by way of example), collectively referred to as the field specifications 308 (also referred to hereinafter as “field definitions”). Specifically, a field specification is provided for each logical field available for composition of an abstract query. Each field specification may contain one or more attributes. Illustratively, the field specifications 308 include a logical field name attribute 320₁, 320₂, 320₃, 320₄, 320₅, 320₆ (collectively, field name 320) and an associated access method attribute 322₁, 322₂, 322₃, 322₄, 322₅, 322₅ (collectively, access methods 322). Each attribute may have a value. For example, logical field name attribute 320₁, has the value “Patient ID” and access method attribute 322₁ has the value “Simple.” Furthermore, each attribute may include one or more associated abstract properties. Each abstract property describes a characteristic of a data structure and has an associated value. In the context of the invention, a data structure refers to a part of the underlying physical representation that is defined by one or more physical entities of the data corresponding to the logical field. In particular, an abstract property may represent data location metadata abstractly describing a location of a physical data entity corresponding to the data structure, like a name of a database table or a name of a column in a database table. Illustratively, the access method attribute 322₁ includes data location metadata “Table” and “Column.” Furthermore, data location metadata “Table” has the value “Patientinfo” and data location metadata “Column” has the value “patient_ID.” Accordingly, assuming an underlying relational database schema in the present example, the values of data location metadata “Table” and “Column” point to a table “Patientinfo” having a column “patient_ID.”

In one embodiment, groups (i.e. two or more) of logical fields may be part of categories. Accordingly, the data abstraction model 232 includes a plurality of category specifications 310₁ and 310₂ (two shown by way of example), collectively referred to as the category specifications. In one embodiment, a category specification is provided for each logical grouping of two or more logical fields. For example, logical fields 308₁₋₃ and 308₄₋₆ are part of the category specifications 310₁ and 310₂, respectively. A category specification is also referred to herein simply as a “category.” The categories are distinguished according to a category name, e.g., category names 330₁ and 330₂ (collectively, category name(s) 330). In the present illustration, the logical fields 308₁₋₃ are part of the “Patient” category and logical fields 308₄₋₆ are part of the “Tests” category.

The access methods 322 generally associate (i.e., map) the logical field names to data in the database (e.g., database 214 of FIG. 2) or data in the external data source (e.g., external data source 246 of FIG. 2). As illustrated in FIG. 3A, the access methods associate the logical field names either to a particular physical data representation 214_{1-N} in the database or to a particular external data source. By way of illustration, two data representations are shown in the database 214, an XML data representation 214₁ and a relational data representation 214₂. However, the physical data representation 214_{N} indicates that any other data representation, known or unknown, is contemplated. In one embodiment, a single data abstraction model 232 contains field specifications (with associated access methods) for two or more physical data representations 214_{1-N}. In an alternative embodiment, a different single data abstraction model 232 is provided for each separate physical data representation 214_{1-N}.

Any number of access methods is contemplated depending upon the number of different types of logical fields to be supported. In one embodiment, access methods for simple fields, filtered fields and composed fields are provided. The field specifications 308₁, 308₂, 308₅ and 308₆ exemplify simple field access methods 322₁, 322₂, 322₅, and 322₆, respectively. The field specification 308₃ exemplifies a filtered field access method 322₃. The field specification 308₄ exemplifies a composed field access method 322₄.

Simple fields can be mapped directly to a particular entity in the underlying physical representation (e.g., a field mapped to a given database table and column) of the database 214. By way of illustration, as described above, the simple field access method 322₁ shown in FIG. 3B maps the logical field name 320₁ (“Patient ID”) to a column named “patient_ID” in a table named “Patientinfo.”

In one embodiment, simple fields can be mapped to external data source 246. By way of illustration, the simple field access method 3222 shown in FIG. 3B maps the logical field 3082 (“Patient Nickname”) to a column named “Nickname” in a temporary table 275. In this example, the temporary table 275 is populated with data from the external data source 246 using a table resolver 270 named “PropertiesPlugin” (“plugin://PropertiesPlugin”). Thus, logical field 308₂ refers to a table that does not exist until the field 308₂ is included in an abstract query. When this occurs, a dynamic, just in time table, is generated for this field using the table resolver “PropertiesPlugin” at query execution.

Illustratively, the designation “PropertiesPlugin” refers to a table resolver that retrieves data for temporary table 275 from external data source 246 (e.g., a file accessible by the query execution unit). In this example, the “PropertiesPlugin” table resolver may be used to generate a temporary table 275 using a text file accessed and parsed by the table generation method.

FIG. 3B illustrates another example of an access method referencing a just in time table. Specifically, access method 322₆ maps the logical field 308₆ (“Tumor Size”) to a column named “tumorsize” a temporary table 275 having data that is retrieved using a table resolver named “SearchEnginePlugin” (plugin://SearchEnginePlugin”). The designation “SearchEnginePlugin” refers to another resolver type that is used to obtain data from external data source 246. For instance, the data returned by the “SearchEnginePlugin” source may be a list of URLs returned by a search engine. Different exemplary table resolver types are described in more detail in the commonly owned co-pending application, entitled “SYSTEM AND METHOD FOR CREATING AND POPULATING DYNAMIC, JUST IN TIME, DATABASE TABLES,” filed herewith (Attorney Docket No. ROC920060100US1), which is hereby incorporated herein in its entirety.

Filtered fields identify an associated physical entity and provide filters used to define a particular subset of items within the physical representation. An example is provided in FIG. 3B in which the filtered field access method 322₃ maps the logical field name 320₃ (“Street”) to a physical entity in a column named “street” in the “Patientinfo” table and defines a filter for individuals in the city of “NY.” Another example of a filtered field is a New York ZIP code field that maps to the physical representation of ZIP codes and restricts the data only to those ZIP codes defined for the state of New York.

Composed access methods compute a logical field from one or more physical fields using an expression supplied as part of the access method definition. In this way, information which does not exist in the underlying physical data representation may be computed. In the example illustrated in FIG. 3B the composed field access method 3224 maps the logical field name 3204 “Normalized Results” to “Results/10.” Another example is a sales tax field that is composed by multiplying a sales price field by a sales tax rate.

It is contemplated that the formats for any given data type (e.g., dates, decimal numbers, etc.) of the underlying data may vary. Accordingly, in one embodiment, the field specifications 308 include a type attribute which reflects the format of the underlying data. However, in another embodiment, the data format of the field specifications 308 is different from the associated underlying physical data, in which case a conversion of the underlying physical data into the format of the logical field is required.

By way of example, the field specifications 308 of the data abstraction model 232 shown in FIG. 3B are representative of logical fields mapped to data represented in the relational data representation 214₂ and the temporary table 275 shown in FIG. 3A. However, other instances of the data abstraction model 232 map logical fields to other physical representations, such as XML.

An illustrative abstract query corresponding to the abstract query 240 shown in FIG. 3B is shown in Table I below. By way of illustration, the illustrative abstract query is defined using XML. However, other languages may be used.

TABLE I
ABSTRACT QUERY EXAMPLE

| | |
|---|---|
| 001 | <?xml version=“1.0”?> |
| 002 | <!--Query string representation: (Tumor Size = ‘25.0’--> |
| 003 | <QueryAbstraction> |
| 004 | <Selection> |
| 005 | <Condition internalID=“4”> |
| 006 | <Condition field=“Tumor Size” operator=“EQ” value=“25.0” |
| 007 | internalID=“1”/> |
| 008 | </Selection> |
| 009 | <Results> |
| 010 | <Field name=“Patient Nickname”/> |
| 011 | </Results> |
| 017 | </QueryAbstraction> |

Illustratively, the abstract query shown in Table I includes a selection specification (lines 004-008) containing selection criteria and a results specification (lines 009-011). In one embodiment, a selection criterion consists of a field name (for a logical field), a comparison operator (=, >, <, etc) and a value expression (what is the field being compared to). In one embodiment, a results specification is a list of abstract fields that are to be returned as a result of query execution. A results specification in the abstract query may consist of a field name and sort criteria. It should be noted that the logical fields selected for the selection criterion (line 006) and the results specification (line 010) in Table I require data that is derived from external data sources as explained in more detail with reference to Table II below. Note, in this example, no reference is made to whether data for the logical fields in this abstract query is stored in database 214 or external data source 264.

An illustrative data abstraction model (DAM) corresponding to the data abstraction model 232 shown in FIG. 3B is shown in Table II below. By way of illustration, the illustrative Data Abstraction Model is defined using XML. However, other languages may be used.

TABLE II
DATA ABSTRACTION MODEL EXAMPLE

| | |
|---|---|
| 001 | <?xml version=“1.0”?> |
| 002 | <DataAbstraction> |
| 003 | <Category name=“Patient”> |
| 004 | <Field queryable=“Yes” name=“Patient ID” |
| | displayable=“Yes”> |
| 005 | <AccessMethod> |
| 006 | <Simple attrName=“patient_ID” |
| | entityName=“Patientinfo”></Simple> |
| 007 | </AccessMethod> |
| 008 | </Field> |
| 009 | <Field queryable=“Yes” name=“Patient Nickname” |
| | displayable=“Yes”> |
| 010 | <AccessMethod> |
| 011 | <Simple attrName =“Nickname” |
| 012 | entityName =“plugin://PropertiesPlugin”></Simple> |
| 013 | </AccessMethod> |
| 014 | </Field> |
| 015 | <Field queryable=“Yes” name=“Street” displayable=“Yes”> |
| 016 | <AccessMethod> |
| 017 | <Filter attrName =“street” entityName =“Patientinfo” |
| 018 | Filter=”Patientinfo.city=NY”> </Filter> |
| 019 | </AccessMethod> |
| 020 | </Field> |
| 021 | </Category> |
| 022 | <Category name=“Tests”> |
| 023 | <Field queryable=“Yes” name=“Normalized Results” |
| | displayable=“Yes”> |
| 024 | <AccessMethod> |
| 025 | <Composed attrName =“results” |
| | entityName =“Bloodtest” |
| 026 | Expression=” attrName /10”> </Composed> |
| 027 | </AccessMethod> |
| 028 | </Field> |
| 029 | <Field queryable=“Yes” name=“Results” |
| | displayable=“Yes”> |
| 030 | <AccessMethod> |
| 031 | <Simple attrName =“results” |
| | entityName =“Bloodtest”></Simple> |
| 032 | </AccessMethod> |
| 033 | </Field> |
| 034 | <Field queryable=“Yes” name=“Tumor Size” |
| | displayable=“Yes”> |
| 035 | <AccessMethod> |
| 036 | <Simple attrName =“tumorsize” |
| 037 | entityName =“plugin:// |
| | SearchEnginePlugin”></Simple> |
| 038 | </AccessMethod> |
| 039 | </Field> |
| 040 | </Category> |
| 041 | </DataAbstraction> |

By way of example, note that lines 009-013 correspond to the field specification 308₂ of the DAM 232 shown in FIG. 3B and lines 034-039 correspond to the field specification 308₆.

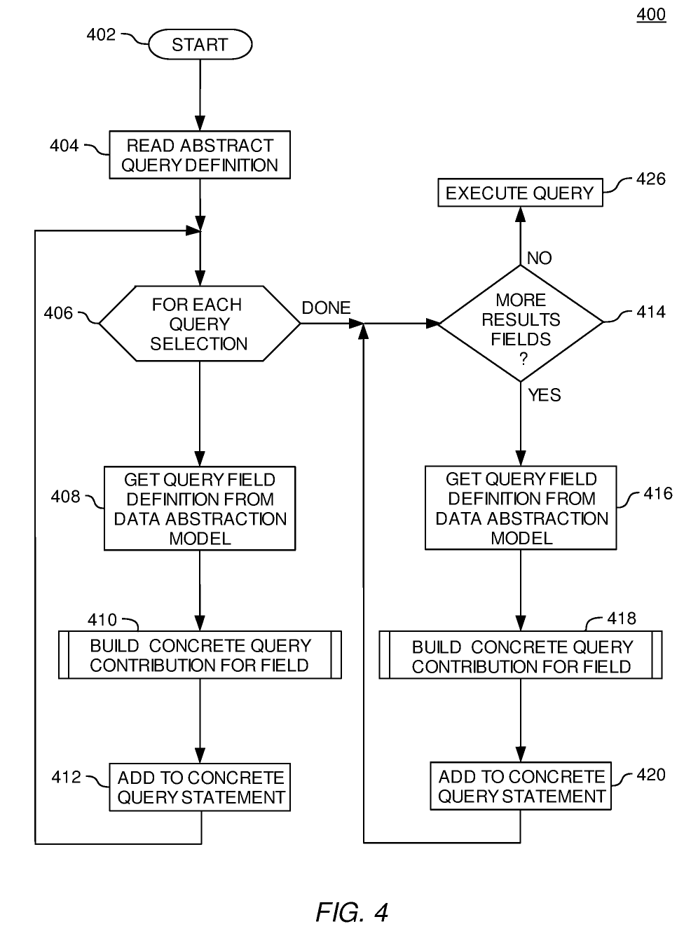

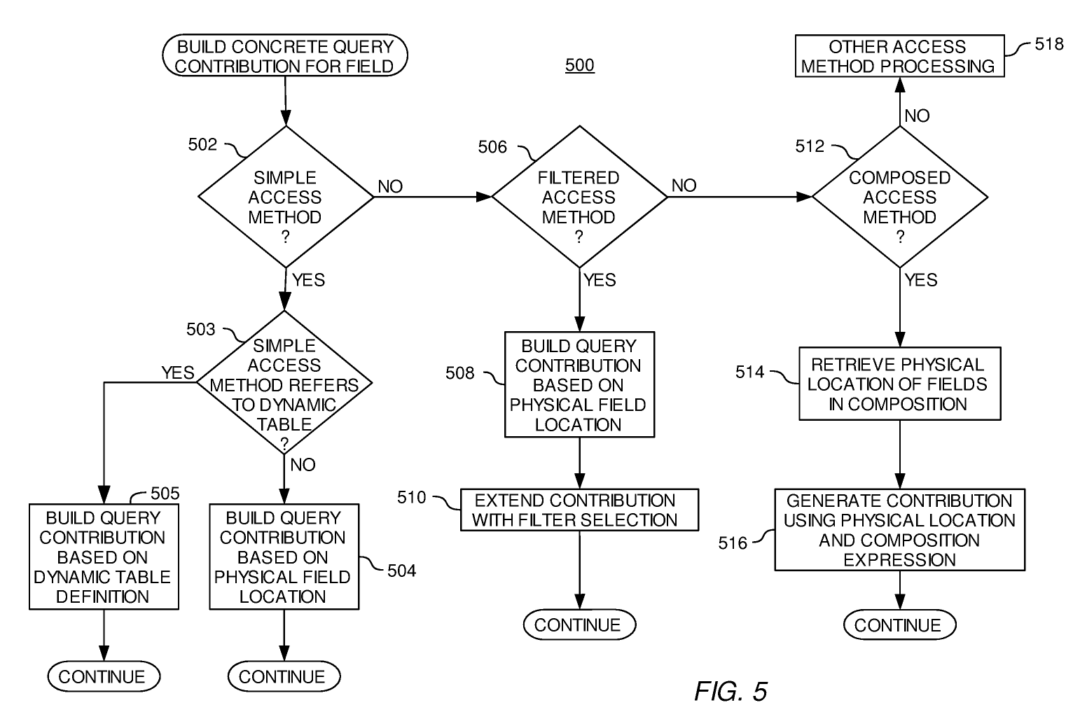

An executable query may be generated from the abstract query of Table I and executed against an underlying database (e.g., database 214 of FIG. 3A) having one or more temporary tables (e.g., temporary table 275 of FIG. 3A). An exemplary method for generating an executable query from an abstract query is described below with reference to FIGS. 4-5.

### Generating an Executable Query from an Abstract Query

FIG. 4, illustrates a method 400 for generating an executable query (also referred to hereinafter as “concrete” query) from an abstract query (e.g., abstract query 240 of FIG. 2) using the runtime component 234 of FIG. 2. The method 400 begins at step 402 when the runtime component 234 receives the abstract query (such as the abstract query shown in Table I). At step 404, the runtime component 234 parses the abstract query and locates selection criteria (e.g., conditions 244 of FIG. 2) and result fields (e.g., result fields 242 of FIG. 2).

At step 406, the runtime component 234 enters a loop (defined by steps 406, 408, 410 and 412) for processing each query selection criteria statement present in the abstract query, thereby building a data selection portion of a concrete query. In one embodiment, a selection criterion consists of a field name (for a logical field), a comparison operator (=, >, <, etc) and a value expression (what is the field being compared to). At step 408, the runtime component 234 uses the field name from a selection criterion of the abstract query to look up the definition of the field in the data abstraction model 232. As noted above, the field definition includes a definition of the access method used to access the data structure associated with the field. The runtime component 234 then builds (step 410) a concrete query contribution for the logical field being processed. As defined herein, a concrete query contribution is a portion of a concrete query that is used to perform data selection based on the current logical field. A concrete query is a query represented in languages like SQL and XML Query and is consistent with the data of a given physical data repository (e.g., a relational database or XML repository). Accordingly, the concrete query is used to locate and retrieve data from the physical data repository, represented by the database 214 having the temporary table 275 shown in FIG. 2. The concrete query contribution generated for the current field is then added to a concrete query statement (step 412). The method 400 then returns to step 406 to begin processing for the next field of the abstract query. Accordingly, the process entered at step 406 is iterated for each data selection field in the abstract query, thereby contributing additional content to the eventual query to be performed.

After building the data selection portion of the concrete query, the runtime component 234 identifies the information to be returned as a result of query execution. As described above, in one embodiment, the abstract query defines a list of result fields, i.e., a list of logical fields that are to be returned as a result of query execution, referred to herein as a result specification. A result specification in the abstract query may consist of a field name and sort criteria. Accordingly, the method 400 enters a loop at step 414 (defined by steps 414, 416, 418 and 420) to add result field definitions to the concrete query being generated. At step 416, the runtime component 234 looks up a result field name (from the result specification of the abstract query) in the data abstraction model 232 and then retrieves a result field definition from the data abstraction model 232 to identify the physical location of data to be returned for the current logical result field. The runtime component 234 then builds (at step 418) a concrete query contribution (of the concrete query that identifies physical location of data to be returned) for the logical result field. At step 420, the concrete query contribution is then added to the concrete query statement. Once each of the result specifications in the abstract query has been processed, processing continues at step 426, where the concrete query is executed.

FIG. 5 illustrates a method 500 for building a concrete query contribution for a logical field according to steps 410 and 418. At step 502, the query engine 254 determines whether the access method associated with the current logical field is a simple access method. If so, it is determined at step 503 whether the simple access method refers to a dynamic table. More specifically, it is determined whether the simple access method refers to an external data source (e.g., external data source 275 of FIG. 2). If so, then a dynamic table is generated prior to executing the concrete query. If so, the concrete query contribution is built (step 505) based on physical data location information for a dynamic table (e.g., temporary table 275 of FIG. 2). More specifically, the query contribution for such a logical field includes a reference to the dynamic table. Prior to query execution, the query execution unit 254 instantiates the table resolver object specified by the logical field and invokes its table generation method to generate the temporary table. Note however, in one embodiment, the temporary table is not generated as part of step 505; instead, just a query contribution that includes a reference to a temporary table is generated. Processing then continues according to method 400 as described above. If, however, it is determined at step 503 that the simple access method does not refer to a dynamic table, the concrete query contribution is built (step 504) based on the physical data location information for an existing database table and processing then continues according to method 400 as described above.

If it is determined at step 502 that the access method associated with the current logical field is not a simple access method, processing continues to step 506 where the query engine 254 determines whether the access method associated with the current logical field is a filtered access method. If so, the concrete query contribution is built (step 508) based on physical data location information for a given data structure(s). At step 510, the concrete query contribution is extended with additional logic (filter selection) used to subset data associated with the given data structure(s). Processing then continues according to method 400 described above. Further, although shown as being referenced by a simple access method, a dynamic, just in time table may be referenced by filtered, composed or other access method types as well.

If the access method is not a filtered access method, processing proceeds from step 506 to step 512 where the query engine 254 determines whether the access method is a composed access method. If the access method is a composed access method, the physical data location for each sub-field reference in the composed field expression is located and retrieved at step 514. At step 516, the physical field location information of the composed field expression is substituted for the logical field references of the composed field expression, whereby the concrete query contribution is generated. Processing then continues according to method 400 described above.

If the access method is not a composed access method, processing proceeds from step 512 to step 518. Step 518 is representative of any other access method types contemplated as embodiments of the present invention. However, it should be understood that embodiments are contemplated in which less then all the available access methods are implemented. For example, in a particular embodiment only simple access methods are used. In another embodiment, only simple access methods and filtered access methods are used.

### Managing Execution of a Query

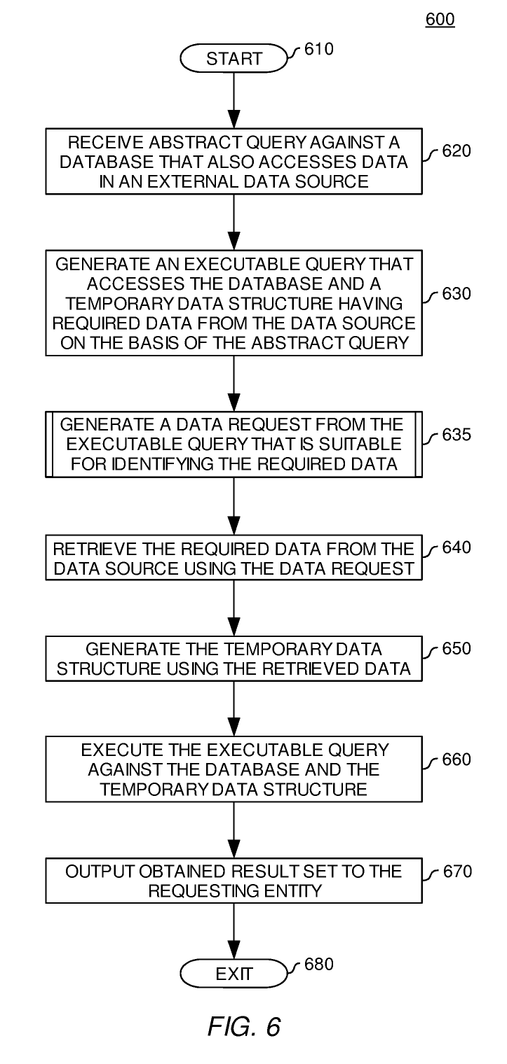

FIG. 6 illustrates an embodiment of a method 600 for managing execution of an abstract query (e.g., abstract query 240 of FIG. 2) issued against a database (e.g., database 214 of FIG. 2) and an external data source (e.g., external data source 246 of FIG. 2). At least some steps of the method 600 may be performed by runtime component 234 of FIG. 2 and/or query execution unit 254 of FIG. 2. The method 600 starts at step 610.

At step 620, an abstract query issued from a requesting entity (e.g., application 220 of FIG. 2) against the database 214 and the external data 246 source is received. Illustratively, assume that application 220 is used to compose and submit the abstract query illustrated in Table III.

TABLE III
ABSTRACT QUERY EXAMPLE

| | |
|---|---|
| 001 | FIND |
| 002 | Patient ID, Document URL |
| 003 | WHERE |
| 004 | Patient ID in (501 to 1550) AND |
| 005 | Document Reference = ‘intraductal carcinoma’ AND |
| 006 | Document Reference = ‘colon carcinoma’ OR |
| 007 | ((Document Reference = ‘colonoscopy’ AND Score > 3) OR |
| 008 | (Document Reference = ‘colonoscopy’ AND Tumor |
| | Size > ’.24’)) |

The exemplary abstract query of Table III includes two result fields (line 002) and is configured to retrieve hyperlinks (“Document URL” in line 002) to specific documents related to patients of a medical institution. Each patient is identified by an associated patient identifier (“Patient ID” in line 002). This exemplary abstract query includes a set of query conditions (lines 004-008) defining a conditional expression. The first condition (line 004) restricts the query results to identifiers that are included in a range of values ranging from 501 to 1550. The second condition (line 005) restricts the query results to hyperlinks that refer to documents containing the search term “intraductal carcinoma.” Other conditions in lines 006-008 restrict the query results to hyperlinks that refer to documents containing either the search term “colon carcinoma,” or the search term ‘colonoscopy’ and a score greater than ‘3,’ or the search term ‘colonoscopy’ and tumor size values greater than “0.24.”

As described in greater detail herein, in one embodiment, the evaluation of these conditions may be split between a data request generated by a table resolver and the query engine evaluating data in a dynamic, just in time table. In this instance, for example, the search engine plug in may be invoked to find documents that include the search terms “intraductal carcinoma” or colon carcinoma. However, until a specific set of documents (or links to documents) with these terms is returned by the search engine, the “score>3” condition and “tumor size>‘24’” condition cannot be evaluated. Thus, this information may be stored in the dynamic, just in time table and evaluated by the query engine when this query is executed.

Table IV illustrates an exemplary data abstraction model corresponding to the abstract query shown in Table III. In this example, the Data Abstraction Model is defined using XML; however, other markup languages may be used.

TABLE IV
DATA ABSTRACTION MODEL EXAMPLE

| | |
|---|---|
| 001 | <?xml version=“1.0”?> |
| 002 | <DataAbstraction> |
| 003 | <Category name=“Documents” hidden=“No”> |
| 004 | <Field displayable=“No” name=“Document Reference” |
| | queryable=“Yes”> |
| 005 | <AccessMethod> |
| 006 | <Simple attrName=“DocRef” |
| 007 | entityName=“plugin://SearchEnginePlugin” /> |
| 008 | </AccessMethod> |
| 009 | </Field> |
| 010 | <Field displayable=“Yes” name=“Document URL” |
| | queryable=“No”> |
| 011 | <AccessMethod> |
| 012 | <Simple attrName=“DocumentID” |
| 013 | entityName=“plugin://SearchEnginePlugin” /> |
| 014 | </AccessMethod> |
| 015 | </Field> |
| 016 | <Field displayable=“Yes” name=“Tumor Size” |
| | queryable=“Yes”> |
| 017 | <AccessMethod> |
| 018 | <Simple attrName=“tumorsize” |
| 019 | entityName=“plugin://SearchEnginePlugin” /> |
| 020 | </AccessMethod> |
| 021 | </Field> |
| 022 | <Field displayable=“Yes” name=“Score” queryable=“Yes”> |
| 023 | <AccessMethod> |
| 024 | <Simple attrName=“score” |
| 025 | entityName=“plugin://SearchEnginePlugin” /> |
| 026 | </AccessMethod> |
| 027 | </Field> |
| 028 | |
| 029 | <Category name=“Hidden Entity Resolver Field” |
| | hidden=“Yes”> |
| 030 | <Field displayable=“Yes” name=“Patient ID” |
| | queryable=“Yes”> |
| 031 | <AccessMethod> |
| 032 | <Simple attrName=“patient_ID” |
| 033 | entityName=“plugin://SearchEnginePlugin” /> |
| 034 | </AccessMethod> |
| 035 | </Field> |
| 036 | </Category> |
| 037 | </Category> |
| 038 | </DataAbstraction> |

As shown in Table IV, the data abstraction model includes definitions for five different logical fields Specifically, a “Document Reference” field (lines 004-009), a “Document URL” field (lines 010-015), a “Tumor Size” field (lines 016-021), a “Score” field (lines 022-027), and a “Patient ID” field (lines 030-035). Each field specification illustratively includes a “displayable” and a “queryable” attribute (lines 004, 010, 016, 022 and 030) having either the value “Yes” or “No.” These attributes are described in more detail in the commonly owned co-pending application, entitled “SYSTEM AND METHOD FOR CREATING AND POPULATING DYNAMIC, JUST IN TIME, DATABASE TABLES,” filed herewith (Attorney Docket No. ROC920060100US1).

By way of example, the “Document Reference” field, the “Document URL” field, the “Tumor Size” field, and the “Score” field are included with a first category (“Documents” in lines 003-027). The “Documents” category relates to information that obtained using a search engine to retrieve information such as document IDs or URLs from the external data source 246. The “Patient ID” field is included with a “Hidden Entity Resolver Field” sub-category (lines 029-036) that is hidden to users (“hidden=“YES”” in line 029). The “Patient ID” field relates to information that is determined using the search engine plugin (line 033) and that is used to link the information retrieved from the external data source to the information included with the database.

By way of example, the steps of method 600 are described below with reference to the abstract query of Table III and the data abstraction model of Table IV. At step 630, the abstract query of Table III is transformed using the data abstraction model of Table IV into the concrete SQL query shown below in Table V. In one embodiment, the transformation is performed as described above with reference to FIGS. 4-5. However, it should be noted that the exemplary concrete query is defined in SQL for purposes of illustration and not limiting of the present invention. For instance, persons skilled in the art will readily recognize corresponding XML representations, such as used to describe the exemplary abstract query of Table I above. All such different implementations are broadly contemplated.

TABLE V
CONCRETE QUERY EXAMPLE

| | |
|---|---|
| 001 | SELECT DISTINCT |
| 002 | “t1”.”patient_ID” AS “Patient ID”, |
| 003 | “t2”.”DocumentID” AS “Document URL”, |
| 004 | FROM |
| 005 | “database”.”Patientinfo” “t1” |
| 006 | LEFT OUTER JOIN SESSION.PluginTable256 “t2” |
| 007 | ON “t1”.”patient_ID” = “t2”.”patient_ID” |
| 008 | WHERE |
| 009 | “t1”.”patient ID” in (501 to 1550) AND |
| 010 | “t2”.”DocRef” = ‘intraductal carcinoma’ AND |
| 011 | “t2”.”DocRef” = ‘colon carcinoma’ OR |
| 012 | ((“t2”.”DocRef” = ‘colonoscopy’ AND “t2”.”score” > 3) OR |
| 013 | (“t2”.”DocRef” = ‘colonoscopy’ AND “t2”.”tumorsize” > |
| | ’.24’)) |

In this example, the results specification in lines 001-003 correspond to the results specification in lines 001-002 of Table III. Similarly, the selection criteria in lines 008-013 correspond to the selection criteria in lines 003-008 of Table III. Lines 002 and 005 access a column “patient ID” in a table “t1” that is defined by the “Patientinfo” table in the database (referred to as “database” in line 005). Lines 003 and 006 access a “DocumentID” column in a temporary table “t2” named “SESSION.PluginTable256.” The temporary “SESSION.PluginTable256” table is populated prior to query execution with data retrieved from the external data source (in this example, query results received from a search engine query).

Note, the table name “SESSION.PluginTable256” is created by the runtime component when generating the SQL query shown in Table V from the corresponding abstract query. For example, the name of a temporary table may be generated as part of step 505 of the method 500 of FIG. 5. By way of example, the temporary table “SESSION.PluginTable256” is joined to the “Patientinfo” table by means of a “patient ID” column provided in both tables (lines 005-007 of Table IV).

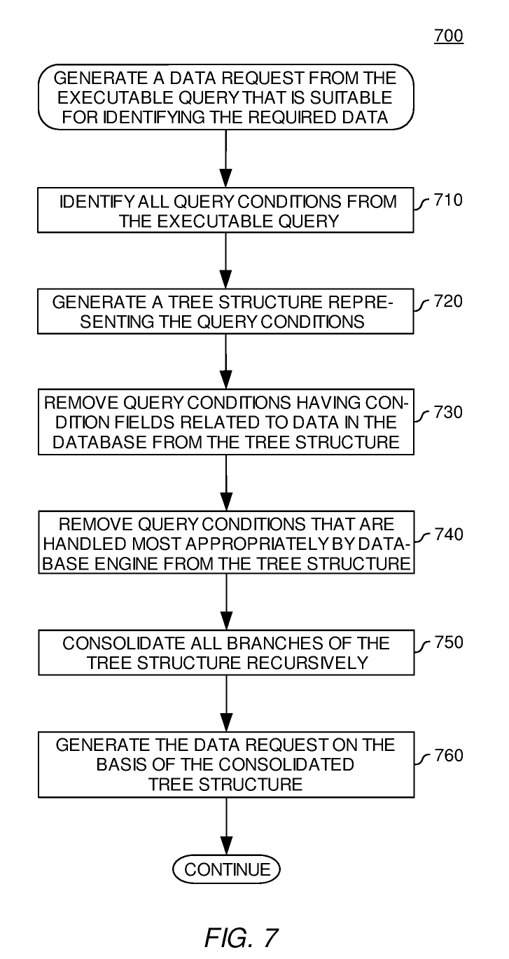

At step 635, a data request 280 is generated for any temporary tables referenced by the executable query. The data request 280 used for identifying data from the external data source to populate the “SESSION.PluginTable256” prior to query execution. In one embodiment, the data request is configured to optimize the data request 280 so that only data necessary for a given query is used to populate the “SESSION.PluginTable256.” A method for generating a suitable data request from the query of Table V is described below with reference to FIGS. 7-13.

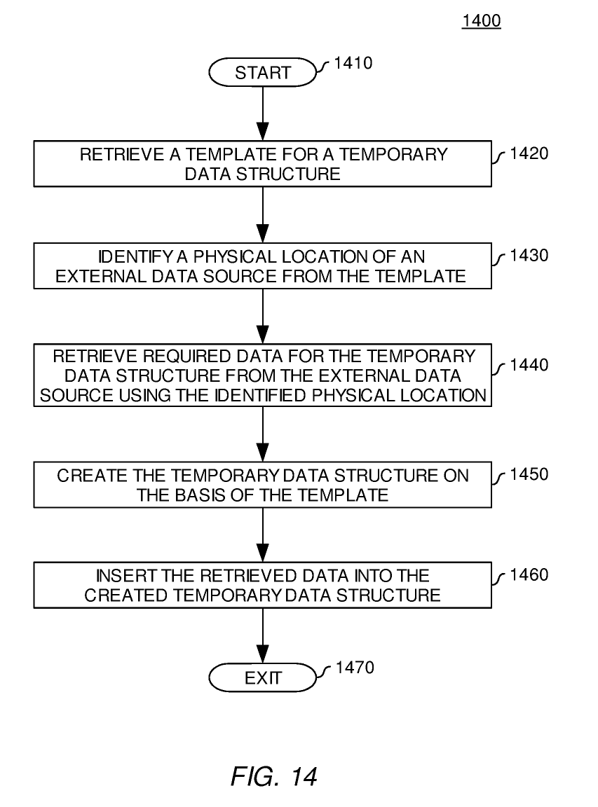

At step 640, the external data source is accessed and data for the “SESSION.PluginTable256” temporary table is retrieved using the generated data request. At step 650, the temporary “SESSION.PluginTable256” table is created and populated with the data from the external data source. In one embodiment, steps 640 and 650 are performed using a table resolver object (e.g., table resolver 270 of FIG. 2). An exemplary method for generating the temporary “SESSION.PluginTable256” table is described below with reference to FIG. 14.

At step 660, the executable query is executed. For example, the SQL query of Table V, may be executed against the database having the “Patientinfo” table and the temporary “SESSION.PluginTable256” table to obtain result set 290. At step 670, the result set is returned to the requesting entity. The method 600 then exits at step 680.

### Generating a Data Request from a Concrete Query

FIG. 7 illustrates one embodiment of a method 700 for generating a data request 280 for data from external data source 246. Data obtained from external data 246 may then be used to populate temporary table 275. In one embodiment, the method 700 is performed as part of step 635 of the method 600 of FIG. 6. The steps of the method 700 may be performed by the query execution unit 254 of FIG. 2. Method 600 is described using the query shown in Table V as an example.

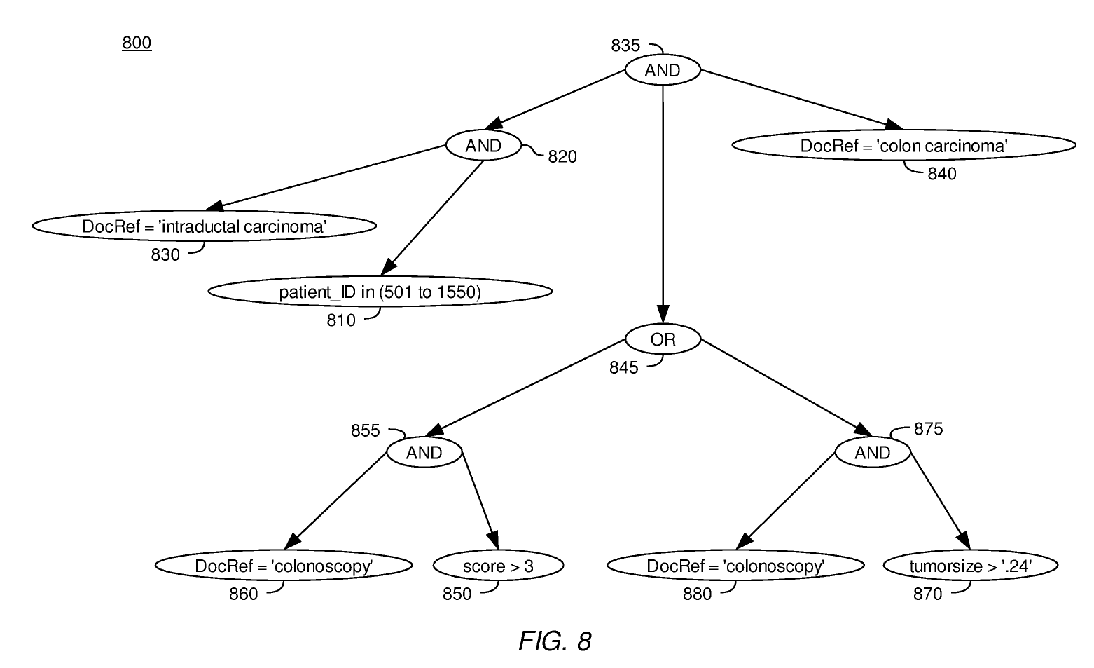

Method 700 begins at step 710 where the conditions included in the concrete query are identified. At step 720, a tree structure representing the query conditions is generated. In one embodiment, each query condition may be represented by a condition node in the tree structure. Boolean AND and/or OR operators connecting query conditions are represented by connector nodes in the tree structure. Thus, one or more branches are created in the tree structure, wherein top level nodes are defined by connector nodes, while each leaf node connects two condition nodes. An exemplary tree structure is described in more detail below with reference to FIG. 8.

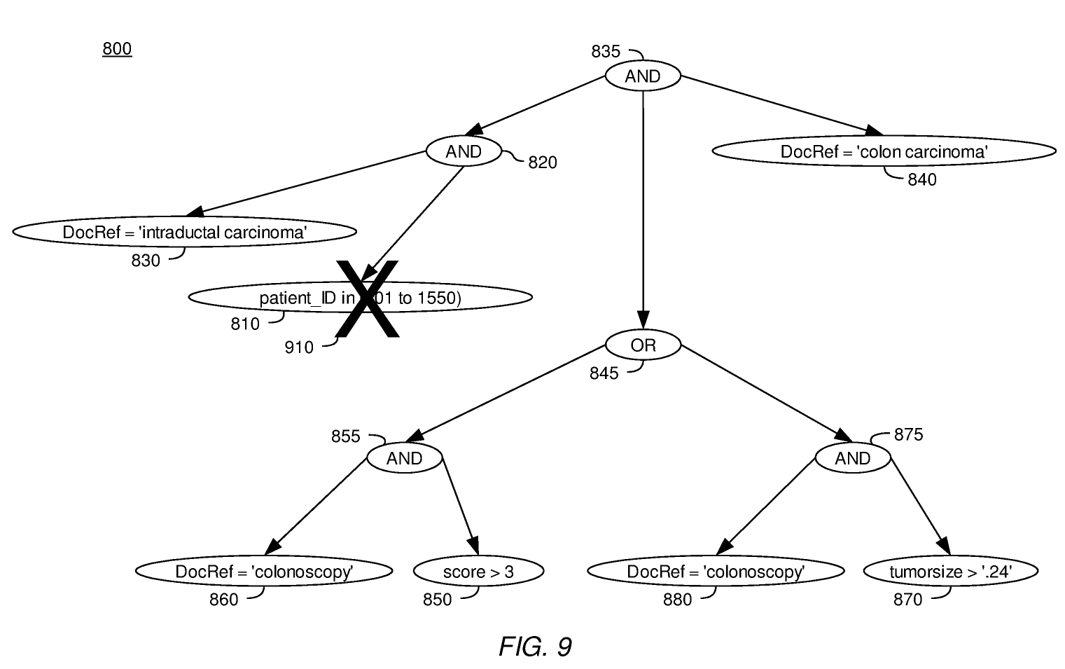

At step 730, nodes with conditions evaluated using data from in the database may be removed from the tree structure. More specifically, condition fields that may only be evaluated when a query is executed, but not when retrieving data from the external data source, may be removed from the tree structure. FIG. 9 illustrates a tree structure with condition nodes removed as part of step 730 using the SQL query shown in Table V.

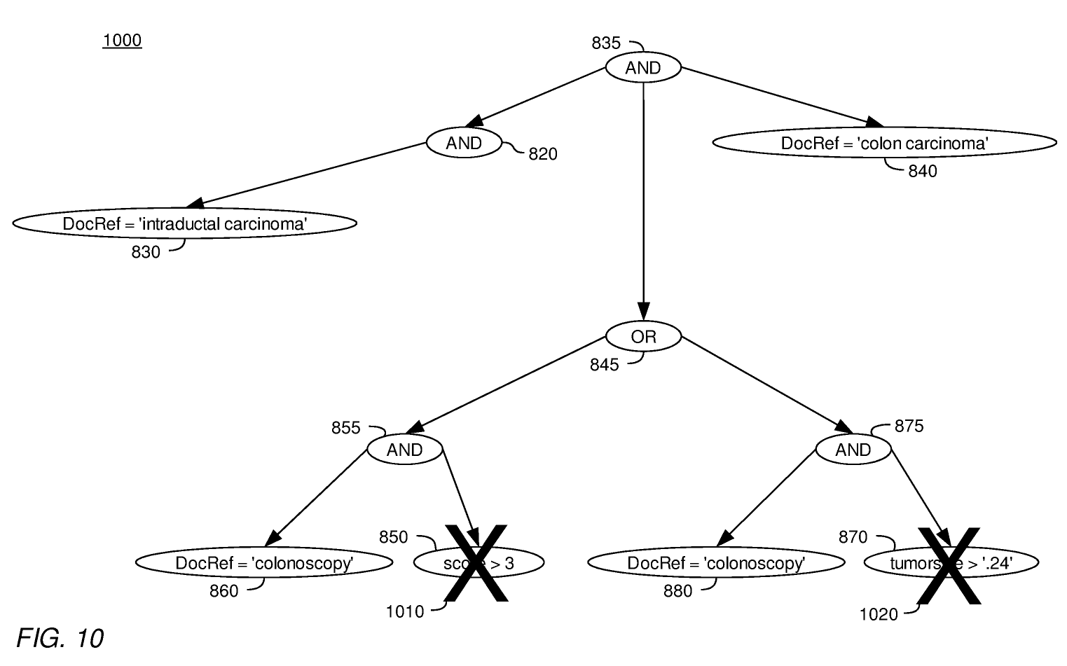

At step 740, condition nodes that are preferably processed by query execution unit at query execution are identified. Such nodes may be removed from the tree structure. For instance, an underlying table resolver object (e.g., table resolver 270 of FIG. 2) may not be configured to process query conditions. By way of example, assume that values of a condition field are determined using data retrieved for temporary table 275. In other words, such conditions may only be evaluated after the temporary table is complete and populated with data from external data source 246. Illustratively, an average of values in a column of the temporary table can only be calculated after data values are stored in the column. Accordingly, the average value may be determined upon when executing the concrete query against the database (and the temporary table). FIG. 10 illustrates a tree structure with condition nodes removed as part of step 740 using the SQL query shown in table V.

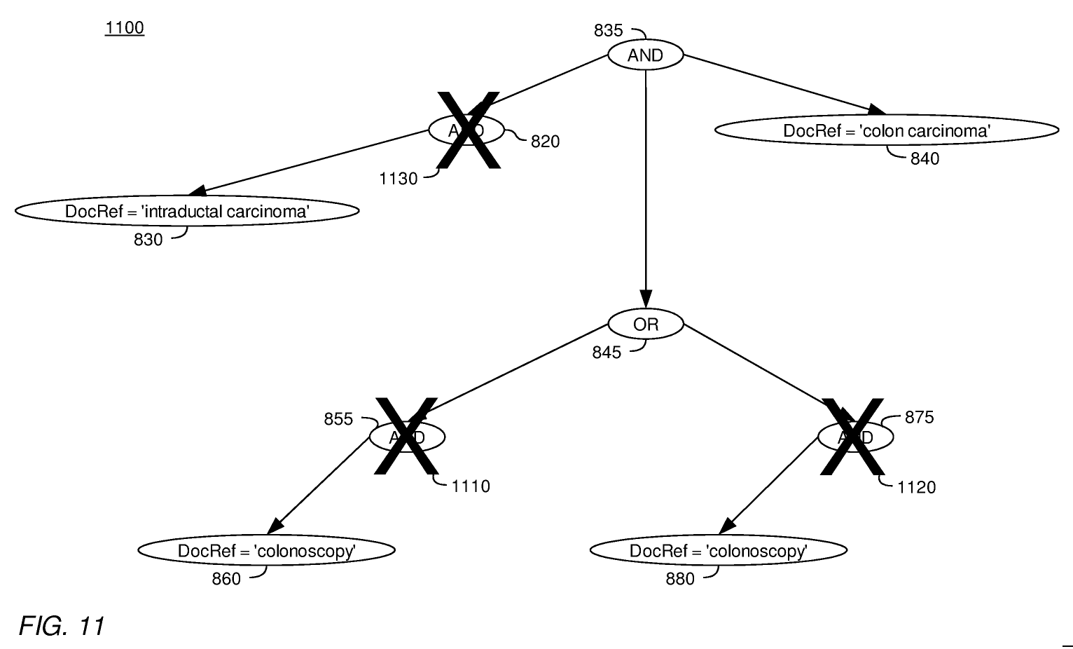

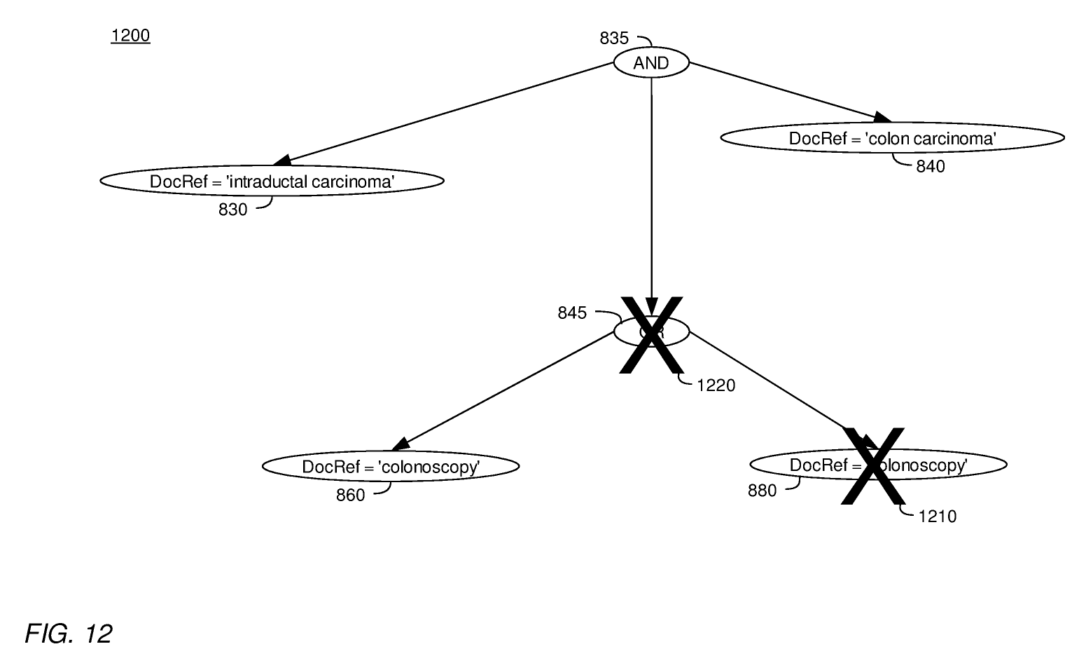

At step 750, the tree structure is consolidated. More specifically, redundant nodes are removed from the tree structure. FIGS. 11-12 illustrate a tree structure with redundant nodes that may be consolidated as part of step 750 using the SQL query shown in table V. This step ensures that the consistency of the tree is maintained as a well formed Boolean condition structure. Without this step, the ability to use a prefix traversal to generate condition text is not maintained as logical operators are expressed within the tree as sometimes requiring only one operand, a clearly invalid result. For example, a statement like (DocRef=‘colonoscopy’ AND) would result from traversing the tree structure without first removing redundant nodes.

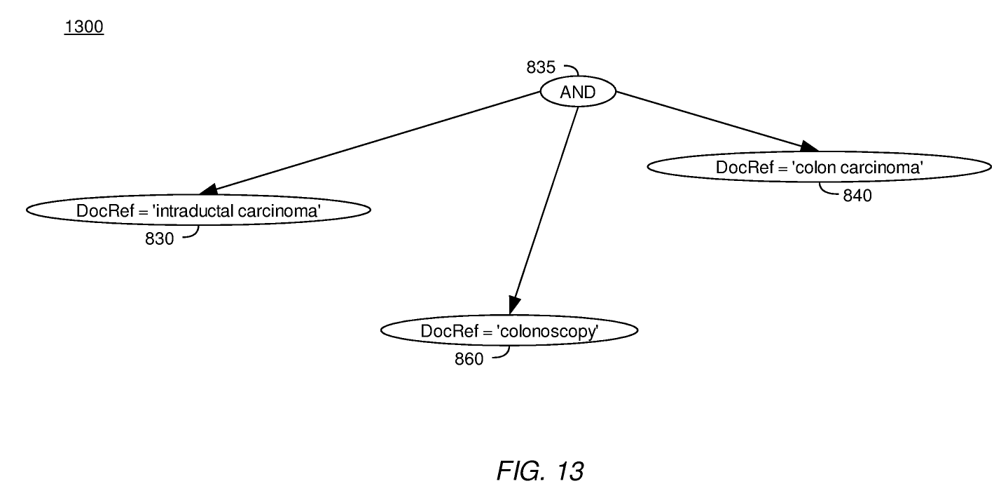

At step 760, the remaining tree structure is used to generate data request 280. FIG. 13 illustrates a tree structure generated from SQL query shown in Table V after being processed according to the method 700.

In one embodiment, the processed tree structure represents a conditional expression having one or more query conditions. This conditional expression is used to define the data request.

TABLE VI
DATA REQUEST EXAMPLE

| | |
|---|---|
| 001 | FIND |
| 002 | DocumentID |
| 003 | FROM |
| 004 | external data source |
| 005 | WHERE |
| 006 | DocRef = ‘intraductal carcinoma’ AND |
| 007 | DocRef = ‘colon carcinoma’ AND |
| 008 | DocRef = ‘colonoscopy’ |

In this example, the data request is used to retrieve hyperlinks (“DocumentID” in line 002) to specific documents that contain three different search terms. More specifically, documents having the terms “intraductal carcinoma”, “colon carcinoma” and “colonoscopy” are retrieved. These documents are retrieved from the search engine (e.g., using the “SearchEnginePlugin” by the table resolver 270 and included in temporary table 275.

### Processing a Tree Structure

FIGS. 8-13 illustrate one embodiment of processing a tree structure. In these figures, the SQL query of Table V is processed according to the method of FIG. 7 and used to generate a data request to retrieve data from an external data source (e.g., external data source 246 of FIG. 2). As was noted above, the SQL query of Table V references two database tables; namely, a “Patientinfo” table and a temporary table “SESSION.PluginTable256.”

FIG. 8 illustrates an exemplary tree structure 800 generated from the conditional expression in lines 009-013 of Table V. As shown, tree structure 800 includes five connector nodes 820, 835, 845, 855 and 875 and seven condition nodes 810, 830, 840, 850, 860, 870 and 880. In this example, nodes 810 and 830 correspond to the query conditions listed on lines 009-010 of Table V. Further, these two nodes are connected by connector node 820 using a Boolean “AND” operator.

FIG. 9 illustrates tree structure 800 after condition node 810 is removed according to step 730 of FIG. 7. More specifically, condition node 810 represents the query condition ““t1”.“patient ID” in (501 to 1550)” shown on line 009 of Table V. This query condition includes the condition field “patient_ID” that relates to the “patient ID” field in the “Patientinfo” database, as indicated by the table reference “t1.” Accordingly, the node 810 is removed from the tree structure, as illustrated by a cross 910.

FIG. 10 illustrates tree structure 800 after the nodes 850 and 870 are removed, according to step 740 of method 700. More specifically, in this example the query conditions ““t2”.“score”>3” (line 012 of Table V) and ““t2”.“tumorsize”>‘0.24’” (line 013 of Table V) are preferably evaluated when the SQL query is executed. Accordingly, the corresponding condition nodes 850 and 870 are removed from the tree structure 1000, as illustrated by crosses 1010 and 1020. Here a weighted analysis of the conditions is done. Noting that values for the “DocRef” condition are only available from the search engine plug-in, this condition is pushed down to this plug-in. It is however recognized that the “AND” conditions on “DocRef” conditions 855 and 875 are both simple numeric comparisons, something database systems excel at over unstructured text query systems (such as Omnifind® search engine in the example of this plug-in). Therefore, the cost of including this information in a dynamic just in time table may be deemed reasonable over pushing these conditions and having the search engine plug-in evaluate these conditions.

FIG. 11 illustrates tree structure 800 after connector nodes 820, 855 and 875 are removed, according to step 750 of FIG. 7. More specifically, when condition nodes 810, 850 and 870 are removed from tree structure 800 (as shown in FIGS. 9-10), connector nodes 820, 855 and 875 no longer contribute to query results. In this case, the “AND” conditions illustrated in these connector nodes no longer have two nodes to perform the logical “AND” operation. Therefore, these connector nodes are removed from tree structure 800, as illustrated by crosses 1110, 1120 and 1130.

FIG. 12 illustrates a tree structure 800 after the modifications illustrated in FIGS. 9-11 have been performed. As shown, connector node 845 and condition node 880 are removed from tree structure 1200, according to step 750 of the method 700. More specifically, when connector nodes 820, 855 and 875, are removed, remaining condition nodes 860, 880 become duplicative. Therefore, one of these nodes may be removed, as illustrated by cross 1210. As a result, the “AND” operation specified by connector node 845 no longer contributes to query results, and is also removed from the tree structure 800, as illustrated by a cross 1220.

FIG. 13 illustrates an exemplary tree structure 1300 that corresponds to the tree structure 800 of FIG. 8 after the modifications illustrated in FIGS. 9-12 have been performed. Tree structure 1300 represents the modified conditional expression used to generate the data request shown in Table VI. The exemplary data request can then be used to generate the temporary table 275, as described above with reference to step 650 of FIG. 6.

### Generating a Temporary Table

FIG. 14 illustrates a method 1400 for generating a temporary data structure (e.g., temporary table 275 of FIG. 2) in a database (e.g., database 214 of FIG. 2), according to one embodiment of the invention. The temporary data structure is generated using data from an external data source (e.g., external data source 246 of FIG. 2). In one embodiment, the method 1400 is performed as part of steps 640 and 650 of the method 600 of FIG. 6.

Method 1400 begins at step 1410 where a request is made to generate a temporary table. In one embodiment, query execution unit 254 may be configured to parse a query generated from an abstract query (as described above) to identify any references to temporary tables. For example, Table VIII illustrates an abstract query composed from the logical fields of the data abstraction model described above. For simplicity, the abstract query of Table VII does not include any query conditions.

TABLE VII
ABSTRACT QUERY EXAMPLE

| | |
|---|---|
| 001 | FIND |
| 002 | Patient ID, Patient Nickname |

As shown, this abstract query includes two result fields that specify to retrieve nicknames (“Patient Nickname”) and corresponding Patient ID values. Table VIII shows an SQL query generated from this abstract query. In one embodiment, the SQL query of Table VIII may be generated using the methods described above in FIGS. 4-5. However, it should be noted that the query is defined in SQL for purposes of illustration and is not limiting the invention. For instance, persons skilled in the art will readily recognize corresponding XML representations, such as used to describe the exemplary abstract query of Table I. Therefore, all such different implementations are broadly contemplated.

TABLE VIII
CONCRETE QUERY EXAMPLE

| | |
|---|---|
| 001 | SELECT DISTINCT |
| 002 | “t1”.”patient_ID” AS “Patient ID”, |
| 003 | “t2”.”Nickname” AS “Patient Nickname” |
| 004 | FROM |
| 005 | “database”.”Patientinfo” “t1” |
| 006 | LEFT OUTER JOIN SESSION.PluginTable250 “t2” |
| 007 | ON “t1”.”patient_ID” = “t2”.”patient_ID |

Lines 002 and 005 specify that this query should retrieve “patient_ID” values from a “t1” table and “Patient Nickname” values from a “t2” table. The “t1” table is an alias to the “Patientinfo” table in an underlying database (line 005). Line 006 shows that the “t2” table of Table VIII is an alias to a “SESSION.PluginTable250.” This table is a dynamic, just in time table. Note the table name of “SESSION.PluginTable250” may be created by a runtime component 234 when generating the SQL query of Table VIII. For example, a name for a temporary table may be generated as part of step 505 of the method 500. In this example, temporary table “SESSION.PluginTable250” is joined to the “Patientinfo” table by means of a “patient_ID” column present in both tables (lines 005-007).

At step 1420, a template for the temporary data structure is retrieved. In one embodiment, the template describes the content and structure of a temporary table generated by an instance of a table resolver object. Table IX shows a template used by the “propertiesPlugin” to generate the SESSION.PluginTable250. The exemplary template is defined using the XML markup language. However, other markup languages may be used to define the content and structure of a temporary table generated by a table resolver object.

TABLE IX
TEMPLATE EXAMPLE

| | |
|---|---|
| 001 | <Extension className=“plugin.PropertiesFileTableResolver” |
| 002 | name=“PropertiesPlugin” |
| | point=“plugin.tableResolver”> |
| 003 | <Parms> |
| 004 | <Field hidden=“Yes” name=“field_1”> |
| 005 | <Type baseType=“char”/> |
| 006 | <Description>Patient ID</Description> |
| 007 | <Value val=“data://Patient/Patient ID”/> |
| 008 | </Field> |
| 009 | <Field hidden=“Yes” name=“field_2”> |
| 010 | <Type baseType=“char”/> |
| 011 | <Description>Patient Nickname</Description> |
| 012 | <Value val=“data://Patient/Patient Nickname”/> |
| 013 | </Field> |
| 014 | <Field hidden=“Yes” name=“location”> |
| 015 | <Type baseType=“char”/> |
| 016 | <Description>Where is the external data |
| | source?</Description> |
| 017 | <Value val=“sample\\nicknames.data”/> |
| 018 | </Field> |
| 019 | </Parms> |
| 020 | <PluginDesc>Exemplary Table Resolver Instance</PluginDesc> |
| 021 | </Extension> |

Table IX illustrates the structure of the SESSION.PluginTable250 generated by the “plugin.PropertiesFileTableResolver” (line 001). In one embodiment, an instance of this object is instantiated to create the temporary table. For example, logical field 308₂ references this plug-in at lines 009-014 of Table II.

As shown, the template includes parameters (“Parms” in lines 003-019) used in the generation of the temporary table. In one embodiment, the parameters specified by the <Parms> elements are passed to the table resolver generation method. In this particular example, the parameters include three exemplary field specifications as shown in lines 004-008 (“field_{—}1”), 009-013 (“field_{—}2”) and 014-018 (“location”).

The field specifications for “field_{—}1” and “field_{—}2” (lines 004-013 of Table IX) indicate a location of these fields in the underlying data abstraction model (lines 007 and 012). Data retrieved for these fields may each be used to populate a column of the temporary table. For instance, “field_{—}2” (line 009) refers to the logical field “Patient Nickname” that is included with the “Patient” category of the underlying data abstraction model (line 012 of Table IX). “Field_{—}1” (line 004) refers to the logical field “Patient ID” that is used to link the temporary data structure to the underlying data abstraction model. The “location” field in lines 014-018 indicates a location of the external data source (“sample\\nicknames.data” in line 017 of Table IX).

At step 1430, the location of the external data source is identified. In the present example, line 017 of the template of Table IX (“sample\\nicknames.data”). At step 1440, data used to populate the temporary data structure may be retrieved from the external data source. In one embodiment, the data is retrieved using a suitable data request (e.g., data request 280 of FIG. 2) as described above.

At step 1450, the temporary data structure is created using the template retrieved at step 1420 and the data retrieved from the external data source at step 1440. More generally, the temporary data structure is created as a temporary table (e.g., temporary table 275 of FIG. 2). In the present example, the temporary table includes a “patient_ID” column corresponding to “field_{—}1” in lines 004-008 of Table IX and a “Nickname” column corresponding to “field_{—}2” in lines 009-013 of Table IX.

At step 1460, the temporary table is populated with the data retrieved from the external data source “sample\\nicknames.data.” Method 1400 then exits at step 1470. Thus, the concrete SQL query of Table VIII that references the temporary data structure (lines 003 and 006-007 of Table VIII) may now be executed. By executing the query against the database and the temporary data structure, a corresponding result set (e.g., result set 290 of FIG. 2) may be obtained. The result set is obtained in a manner that is similar to execution of a query against a database that does not include a temporary table.

While the foregoing is directed to embodiments of the present invention, other and further embodiments of the invention may be devised without departing from the basic scope thereof, and the scope thereof is determined by the claims that follow.

What is claimed is:

1. A computer-implemented method of processing a database query, comprising:
receiving, from a requesting entity, an abstract query of data contained in a database and an external data source, wherein the abstract query is composed from one or more logical fields of a data abstraction model;
generating, from the abstract query, an executable query capable of being executed by a query engine, wherein the executable query includes a reference to a temporary data structure to be generated using data from the external data source and wherein the executable query includes one or more query conditions;
generating a data request specifying data from the external data source required to execute the database query, wherein the data request includes at least one of the plurality of conditions;
generating the temporary data structure using the data request to retrieve data from the external data source consistent with the at least one condition; and
executing the executable query against the database and the temporary data structure to obtain a result set.

2. The method of claim 1, further comprising:
retrieving a template for the temporary data structure, the template defining a configuration of the temporary data structure and specifying a location of the external data source;
retrieving data from the external data source using the location specified by the template;
creating the temporary data structure according to the configuration defined by the template; and
inserting data retrieved from the external data source using the data request into the temporary data structure.

3. The method of claim 1, wherein the database includes one or more database tables and wherein creating the temporary data structure comprises creating a temporary database table in the database containing data retrieved from the external data source.

4. The method of claim 1, wherein the executable query includes a reference to the temporary data structure, and wherein the executable query and the data request are generated prior to the generation of the temporary data structure.

5. The method of claim 1, wherein the data abstraction model is configured to generate the executable query in a form consistent with a physical representation of the data in the database and the temporary data structure on the basis of the one or more logical fields of the abstract query.

6. The method of claim 1, further comprising:
generating a tree structure having a plurality of nodes representing the plurality of query conditions included with the executable query; and
modifying the tree structure to create a modified tree structure having only nodes related to query conditions to select the data from the external data source.

7. The method of claim 6, wherein modifying the tree structure comprises:
identifying query conditions from the plurality of query conditions that relate to data available from the database; and
removing all nodes related to the query condition from the tree structure.

8. A computer-readable medium containing a program which, when executed by a processor, performs operations for processing a database query, the operations comprising:
receiving, from a requesting entity, an abstract query of data contained in a database and an external data source, wherein the abstract query is composed from one or more logical fields of a data abstraction model;
generating, from the abstract query, an executable query capable of being executed by a query engine, wherein the executable query includes a reference to a temporary data structure to be generated using data from the external data source and wherein the executable query includes one or more query conditions;
generating a data request specifying data from the external data source required to execute the database query, wherein the data request includes at least one of the plurality of conditions;
generating the temporary data structure using the data request to retrieve data from the external data source consistent with the at least one condition; and
executing the executable query against the database and the temporary data structure to obtain a result set.

9. The computer-readable medium of claim 8, wherein the operations further comprise:
retrieving a template for the temporary data structure, the template defining a configuration of the temporary data structure and specifying a location of the external data source;
retrieving data from the external data source using the location specified by the template;
creating the temporary data structure according to the configuration defined by the template; and
inserting data retrieved from the external data source using the data request into the temporary data structure.

10. The computer-readable medium of claim 8, wherein the database includes one or more database tables and wherein creating the temporary data structure comprises creating a temporary database table in the database containing data retrieved from the external data source.

11. The computer-readable medium of claim 8, wherein the executable query includes a reference to the temporary data structure, and wherein the executable query and the data request are generated prior to the generation of the temporary data structure.

12. The computer-readable medium of claim 8, wherein the data abstraction model is configured to generate the executable query in a form consistent with a physical representation of the data in the database and the temporary data structure on the basis of the one or more logical fields of the abstract query.

13. The computer-readable medium of claim 8, wherein the operations further comprise:
generating a tree structure having a plurality of nodes representing the plurality of query conditions included with the executable query; and
modifying the tree structure to create a modified tree structure having only nodes related to query conditions to select the data from the external data source.

14. The computer-readable medium of claim 13, wherein modifying the tree structure comprises:
identifying a query condition from the plurality of query conditions that relates to data available from the database; and
removing all nodes related to the query condition from the tree structure.

15. A computing device, comprising:
a processor; and
a memory containing a program for optimizing a database query, which, when executed, performs an operation for processing a database query, comprising:
receiving, from a requesting entity, an abstract query of data contained in a database and an external data source, wherein the abstract query is composed from one or more logical fields of a data abstraction model;
generating, from the abstract query, an executable query capable of being executed by a query engine, wherein the executable query includes a reference to a temporary data structure to be generated using data from the external data source and wherein the executable query includes one or more query conditions;
generating a data request specifying data from the external data source required to execute the database query, wherein the data request includes at least one of the plurality of conditions;
generating the temporary data structure using the data request to retrieve data from the external data source consistent with the at least one condition; and
executing the executable query against the database and the temporary data structure to obtain a result set.

16. The computing device of claim 15, wherein the operations further comprise:
retrieving a template for the temporary data structure, the template defining a configuration of the temporary data structure and specifying a location of the external data source;
retrieving data from the external data source using the location specified by the template;
creating the temporary data structure according to the configuration defined by the template; and
inserting data retrieved from the external data source using the data request into the temporary data structure.

17. The computing device of claim 15, wherein the database includes one or more database tables and wherein creating the temporary data structure comprises creating a temporary database table in the database containing data retrieved from the external data source.

18. The computing device of claim 15, wherein the executable query includes a reference to the temporary data structure, and wherein the executable query and the data request are generated prior to the generation of the temporary data structure.

19. The computing device of claim 15, wherein the data abstraction model is configured to generate the executable query in a form consistent with a physical representation of the data in the database and the temporary data structure on the basis of the one or more logical fields of the abstract query.

20. The computing device of claim 15, wherein the operations further comprise:
generating a tree structure having a plurality of nodes representing the plurality of query conditions included with the executable query; and
modifying the tree structure to create a modified tree structure having only nodes related to query conditions to select the data from the external data source.

21. The computing device of claim 20, wherein modifying the tree structure comprises:
identifying query conditions from the plurality of query conditions that relate to data available from the database; and
removing all nodes related to the query condition from the tree structure.
